(19) United States
(12) Patent Application Publication
(10) Pub. No.: US 2020/0183367 A1
(43) Pub. Date: Jun. 11, 2020

(54) PROGRAM DEVELOPMENT SUPPORT DEVICE AND METHOD FOR MANAGING PROGRAM COMPONENT

(71) Applicant: Mitsubishi Electric Corporation, Tokyo (JP)

(72) Inventors: Yoshio USUI, Aichi (JP); Atsushi OGATA, Aichi (JP)

(73) Assignee: Mitsubishi Electric Corporation, Tokyo (JP)

(21) Appl. No.: 16/339,374

(22) PCT Filed: Dec. 22, 2016
(86) PCT No.: PCT/JP2016/088427

§ 371 Date: Apr. 4, 2019

(51) Int. Cl. G05B 19/418; G06F 8/36

(52) U.S. Cl. CPC G05B 19/4188; G05B 19/4183; G06F 8/36

(57) ABSTRACT

A program development support device that manages program components on a project basis includes: a program component creating unit that adds a name to each of the program components; and a program component managing unit that identifies identity between a plurality of the program components when the program components are combined, based on a program component name and specification information, the program component name being the name added by a user to corresponding one of the program components by using the program component creating unit, the specification information being creation information specified by the user among a plurality of types of the creation information that is information relating to creation of the corresponding one program component.

### FIELD

The present invention relates to a program development support device that supports development of a program for controlling industrial equipment and the like, and a method for managing a program component.

### BACKGROUND

A conventional invention for supporting development of a control program for industrial equipment is described in Patent Literature 1. A program creation support device described in Patent Literature 1 supports creation of a control program in a control system in which one control device that plays a comprehensive role controls a plurality of control devices having the same functions. The program creation support device described in Patent Literature 1 makes it possible to use the same label name in each program of the plurality of control devices by describing a name to which information indicating a reference source is added in the label name to identify the label by using the label name.

### CITATION LIST

### Patent Literature

Patent Literature 1: Japanese Patent Application Laid-open No. 2007-265252

### SUMMARY

### Technical Problem

Generally, development of a program is carried out by a plurality of developers sharing work. That is, each of the developers individually creates one or more programs which each one is in charge of, and eventually combine the programs created by the developers to complete one program. In this combining work, the developers check whether or not the same names are not given to different variables, functions, and the like in the programs individually created. Then, in a case where a name is duplicated, work is performed for changing the name to eliminate the duplication. A case is conceivable where the developers perform coordination in advance to avoid duplication; however, in that case, time for the coordination occurs. In addition, a case is also conceivable where coordination is required again as work proceeds, and work efficiency is reduced.

The present invention has been made in view of the above, and it is an object to obtain a program development support device that improves work efficiency of program development.

### Solution to Problem

To solve the above problem and achieve an object, there is provided a program development support device according to the present invention to manage program components on a project basis, the program development support device including: a program component creating unit to add a name to each of the program components; and a program component managing unit to identify identity between a plurality of the program components when the program components are combined, based on a program component name and specification information, the program component name being a name added by a user to corresponding one of the program components by using the program component creating unit, the specification information being creation information specified by the user among a plurality of types of the creation information that is information relating to creation of the corresponding one program component.

### Advantageous Effects of Invention

The program development support device according to the present invention has an effect that work efficiency of program development can be improved.

### BRIEF DESCRIPTION OF DRAWINGS

FIG. 1 is a diagram illustrating a configuration example of a program development support device according to a first embodiment.

FIG. 2 is a diagram illustrating an example of a program component table used by the program development support device according to the first embodiment.

FIG. 3 is a flowchart illustrating an operation example of the program development support device according to the first embodiment.

FIG. 4 is a flowchart illustrating an operation example of a creation information specifying unit according to the first embodiment.

FIG. 5 is a diagram illustrating a screen display example of the creation information specifying unit according to the first embodiment.

FIG. 6 is a diagram for explaining a method for using an identification pattern in the program development support device according to the first embodiment.

FIG. 7 is a diagram illustrating an operation example of the creation information specifying unit according to the first embodiment.

FIG. 8 is a diagram illustrating an example of data stored in a storage unit according to the first embodiment.

FIG. 9 is a flowchart illustrating an example of operation in which the program development support device according to the first embodiment combines program components.

FIG. 10 is a diagram illustrating a configuration example of a program component to which specification information is added by the program development support device according to the first embodiment.

FIG. 11 is a flowchart illustrating an operation example of the creation information specifying unit according to a second embodiment.

FIG. 12 is a diagram illustrating a display example of a menu screen that allows a user to specify creation information to be displayed together with a program component by the program development support device according to the second embodiment.

FIG. 13 is a diagram illustrating a display example of program components by the program development support device according to the second embodiment.

FIG. 14 is a flowchart illustrating an operation example of the program development support device according to a third embodiment.

FIG. 15 is a diagram illustrating a hardware configuration example of the program development support device according to the first to third embodiments.

### DESCRIPTION OF EMBODIMENTS

Hereinafter, a program development support device and a method for managing a program component according to embodiments of the present invention will be described in detail with reference to the drawings. Incidentally, the invention is not limited to the embodiments.

### First Embodiment

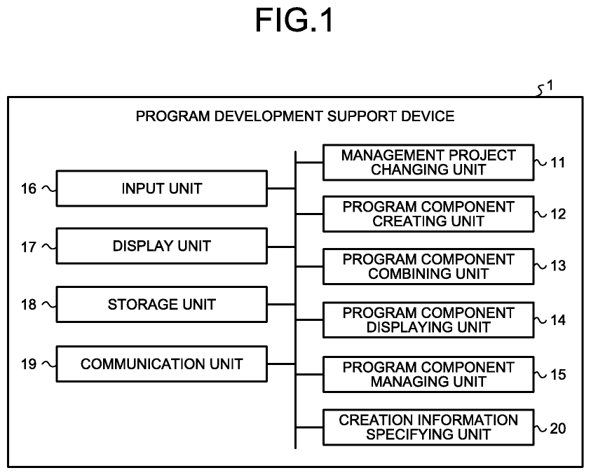

FIG. 1 is a diagram illustrating a configuration example of a program development support device according to a first embodiment of the present invention. A program development support device 1 according to the first embodiment includes a management project changing unit 11, a program component creating unit 12, a program component combining unit 13, a program component displaying unit 14, a program component managing unit 15, an input unit 16, a display unit 17, a storage unit 18, a communication unit 19, and a creation information specifying unit 20.

The management project changing unit 11 newly creates or changes a project that includes one or more program components. Changing of the project also includes a function to transfer the program component between projects. The project is a unit for managing one or more program components. The program components constitute a program for operating industrial equipment. Examples of the program component include a variable, data type, a function, and the like. In addition, an aggregate of the variable, the data type, the function, and the like, specifically, a list, a library, and the like are also program components.

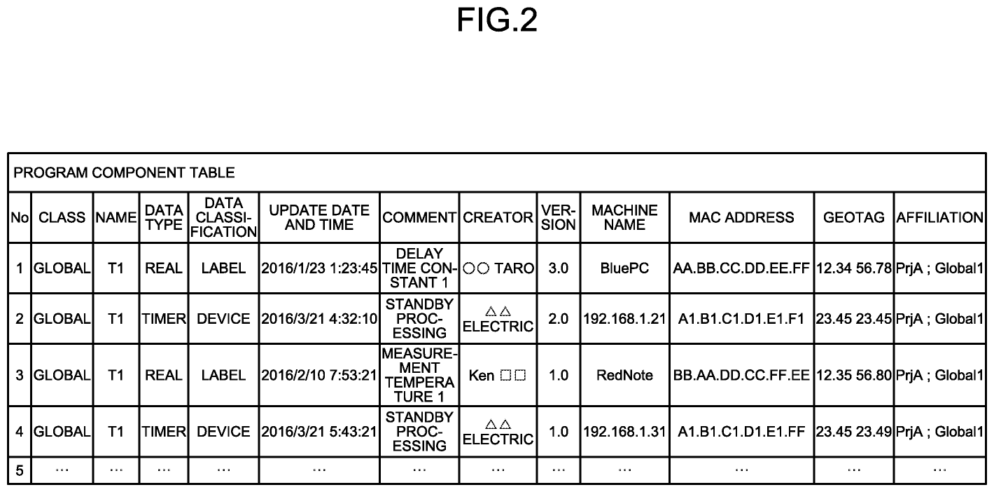

The program component creating unit 12 creates and edits the program component in accordance with operation performed by a user. The program component creating unit 12 adds to the program component a name determined by the user of the program development support device 1, that is, a name determined by the useron the basis of a function or a meaning of the program component. In addition, the program component creating unit 12 generates and updates a program component table including a name of the program component and creation information. The name of the program component is added to the program component by the user of the program development support device 1. The creation information is various types of information relating to creation of the program component, and is inevitably generated in a creating process of the program component. FIG. 2 is a diagram illustrating an example of the program component table. The program component table illustrated in FIG. 2 includes pieces of information on a class, a name, a data type, a data classification, an update date and time, a comment, a creator, a version, a machine name, a media access control (MAC) address, a geotag, and affiliation of each program component. The “version” is information updated each time the program component is changed. The “affiliation” is information indicating that the program component is affiliated to which aggregate of which project. Among the pieces of information registered in the program component table, other pieces of information, excluding the “name” given by the user, correspond to the creation information that is inevitably generated when the program component is created. Incidentally, the configuration illustrated in FIG. 2 is merely an example, and the program component table may have a configuration further including other pieces of information (not illustrated), or excluding a part of the pieces of information illustrated. The program component table is stored in the storage unit 18.

The program component combining unit 13 combines the program components managed by the program development support device 1 to generate an executable file for operating the industrial equipment. When combining the program components, the program component combining unit 13 uses an identification result of the program components obtained by the program component managing unit 15. Specifically, in a case where the program component managing unit 15 determines that, among program components that are targets of the combining, some program components having the same names and being different from each other exist on the program component table, and pieces of specification information of these program components having the same names are different from each other, the program component combining unit 13 treats the program components having the same names as different program components and combines the program components. In addition, in a case where the program component managing unit 15 determines that, among program components that are targets of the combining, program components having the same names and being different from each other exist on the program component table, and pieces of specification information of these program components having the same names are the same as each other, the program component combining unit 13 performs operation of displaying on the display unit 17 an indication that the program components to be combined are duplicated to notify the user.

The program component displaying unit 14 generates various screen data for allowing the user to check the program components, and displays the data on the display unit 17. The program component displaying unit 14 visualizes the program components to be displayed on the display unit 17, based on the name of the program component and the creation information. Because the program component displaying unit 14 visualizes the program component by using the creation information in addition to the name of the program component, even when the plural program components having the same names exist, the user checking program components displayed on the display unit 17 can identify that the program components are different from each other.

The program component managing unit 15 identifies each program component, based on the name of the program component and the specification information that is creation information specified by the user among various types of creation information of the program component. That is, the program component managing unit 15 identifies whether or not the program components managed by the program development support device 1 are the same as each other, based on the name and the specification information of each program component.

The input unit 16 includes a mouse, a keyboard, and other operation input devices, accepts operation performed by the user for developing a program, and generates input information indicating contents of the operation.

The display unit 17 is a display, and displays various types of information for the user.

The storage unit 18 stores various data including the program components, the program component table, the various screen data to be displayed on the display unit 17, and setting information of the program development support device 1.

The communication unit 19 communicates with the industrial equipment and a computer having another project file via a communication network (not illustrated).

The creation information specifying unit 20 accepts from the user specification of the creation information to be used by the program component managing unit 15 in identification of the program components, that is, specification of which creation information is used as the specification information and combined with the name, to be used in identification of the program components, among pieces of creation information registered in the program component table.

Here, in the program component table illustrated in FIG. 2, the “name” indicates names of program components No. 1 to No. 4. The program component No. 1 is a label having a name “T1” indicating a delay time constant (Time). The program components No. 2 and No. 4 are devices each having the name “T1” indicating a standby processing (Timer) using a timer function, the program component No. 3 is a label having the name “T1” indicating a measurement temperature (Temperature). That is, the program components managed by the program component managing unit 15 include four program components whose names are duplicated.

The program development support device 1 according to the first embodiment is enabled to combine the plural program components having duplicated names in a state where the names are duplicated. Thus, the user of the program development support device 1 does not have to perform work for preventing occurrence of duplication of names, and work for eliminating the duplication of the names in a case where the duplication has occurred, so that reduction of a work load and shortening of development time can be achieved.

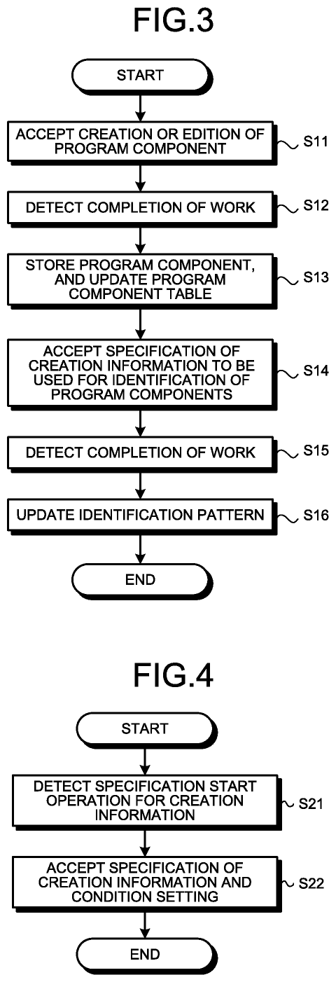

FIG. 3 is a flowchart illustrating an operation example of the program development support device 1 according to the first embodiment. Specifically, FIG. 3 illustrates operation in which the program development support device 1 creates and stores the program component.

The program development support device 1 accepts operation for creating work or editing work of the program component performed by the user (step S11), and when detecting operation indicating completion of the work (step S12), executes processing indicated in steps S13 to S16. In steps S11 and S12, the program component creating unit 12 accepts the operation by the user via the input unit 16, and creates or edits the program component in accordance with contents of the operation accepted. In step S11, the user of the program development support device 1 performs work of determining or changing the name of the program component, and also performs work of creating or editing the program component.

When detecting the operation indicating the completion of the work in step S12, the program development support device 1 stores the program component and updates the program component table (step S13). In step S13, the program component creating unit 12 stores in the storage unit 18 the program component created or edited in step S11, and further updates the program component table stored in the storage unit 18, specifically, the program component table illustrated in FIG. 2. In a case where a new program component is created, the program component creating unit 12 registers information of the program component created, that is, the class, name, data type, data classification, and the like in the program component table. In addition, in a case where an existing program component is edited, the program component creating unit 12 updates information in the program component table corresponding to the program component updated by edition.

Next, the program development support device 1 accepts the specification of the creation information to be used for identification of the program components (step S14). In step S14, the creation information specifying unit 20 accepts operation from the user, that is, the specification of the creation information to be used for identification of the program components. Here, operation will be described of the creation information specifying unit 20.

FIG. 4 is a flowchart illustrating an operation example of the creation information specifying unit 20. When detecting that specification start operation for the creation information has been performed by the user (step S21), the creation information specifying unit 20 displays a specification screen of the creation information on the display unit 17 illustrated in FIG. 1, and accepts the specification of the creation information by the user, and setting of a condition for using the creation information specified (step S22). When accepting the specification of the creation information by the user and the setting of the condition for using the creation information specified, the creation information specifying unit 20 generates an identification pattern that is information indicating contents accepted, and stores the identification pattern in the storage unit 18. Details of the identification pattern will be described separately. Incidentally, in a case where the identification pattern generated in the past is stored in the storage unit 18, in step S22, the creation information specifying unit 20 reads from the storage unit 18 the identification pattern already generated and displays the identification pattern on the display unit 17, and accepts edition of the identification pattern.

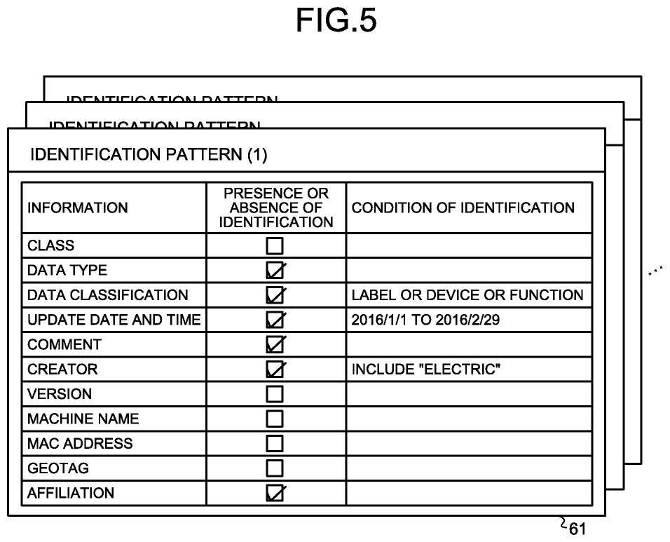

In step S22, the creation information specifying unit 20 displays on the display unit 17 a screen 61 or the like illustrated in FIG. 5, and accepts input of “presence or absence of identification” and “condition of identification” by the user. The “presence or absence of identification” is a setting item for specifying whether or not to use corresponding creation information for identification of the program components. The program development support device 1 accepts from the user a check of a check box of the “presence or absence of identification” of the creation information to be used for identification of the program components. The “condition of identification” is an item for setting a specific condition to be used in determination of the creation information in a case where a determination result as to whether or not corresponding creation information satisfies the specific condition is used as the specification information. The “presence or absence of identification” and the “condition of identification” are combined to be the identification pattern described above. When accepting operation of completion of the work, the creation information specifying unit 20 confirms which check box of the “presence or absence of identification” is checked at that point and a condition entered in the “condition of identification”, and generates the identification pattern. The creation information specifying unit 20 stores in the storage unit 18 the identification pattern generated. The identification pattern is information indicating the creation information whose check box is checked, that is, the creation information specified by the user, and the condition of identification corresponding to each piece of the creation information specified. The identification pattern is information indicating the creation information to be used in identification of the program components. The creation information specifying unit 20 accepts the operation of the completion of the work even in a case where there is no check box checked. In a case where the creation information specifying unit 20 generates the identification pattern in a state where one or more check boxes of the “presence or absence of identification” is checked, the program component managing unit 15 identifies the program components by using the name of the program component and the specification information that is the creation information specified by the user, that is, the creation information whose check box is checked. The program development support device 1 may hold two or more identification patterns. FIG. 5 illustrates an example in a case where the program development support device 1 holds a plurality of the identification patterns. Incidentally, in a case where the program development support device 1 holds the plurality of identification patterns, the program development support device 1 selects one of the plurality of identification patterns, and identifies the program components by using the creation information indicated by the selected identification pattern. In this case, the program development support device 1 allows the user to specify the identification pattern via the input unit 16.

In the example of an identification pattern (1) illustrated in the screen 61 of FIG. 5, the creation information whose check box of the presence or absence of identification is checked, that is, the creation information to be used for identification of the program components includes the “data type”, “data classification, “update date and time”, “comment”, “creator”, and “affiliation”. Regarding the “data type”, “comment”, and “affiliation” among these pieces of creation information, because the “condition of identification” is not specified, the information itself registered in the program component table is used in identification of the program components. In addition, regarding the “data classification”, “update date and time”, and “creator”, because the “condition of identification” is set, information of the determination result as to whether or not the set condition is satisfied is used in identification of the program components.

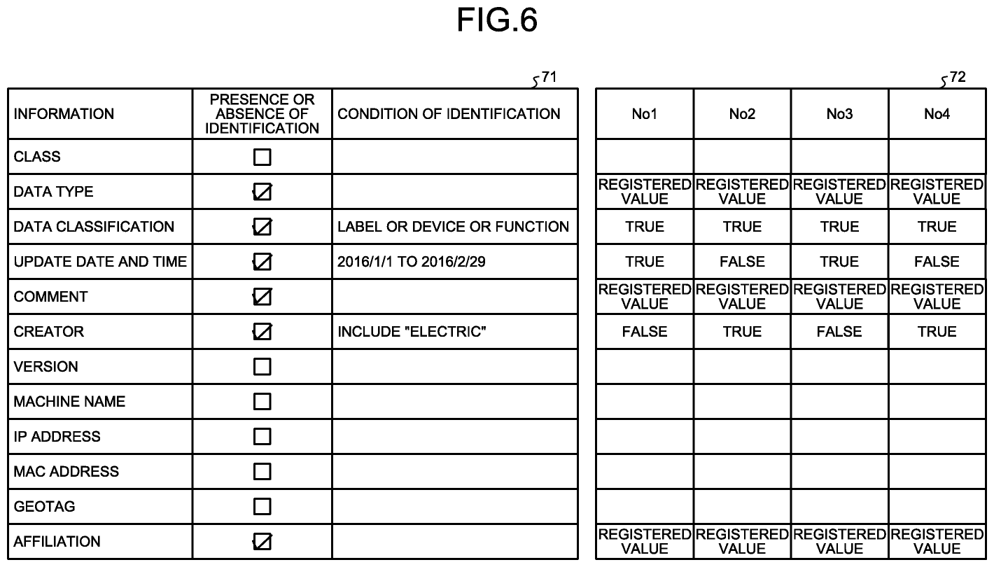

A method for using the identification pattern will be described with reference to the program component table illustrated in FIG. 2, and FIG. 6. FIG. 6 is a diagram for explaining the method for using the identification pattern.

In FIG. 6, a display 71 shows setting contents corresponding to the identification pattern (1) illustrated in FIG. 5. In addition, a display 72 indicates information to be used in a case where the program components are identified in accordance with the identification pattern (1). No. 1 to No. 4 of the display 72 respectively correspond to No. 1 to No. 4 of the program component table illustrated in FIG. 2. A column of “registered value” on the display 72 indicates that corresponding creation information is used in identification of the program components. That is, the information corresponding to the column of “registered value” is information in which the “presence or absence of identification” is checked and the “condition of identification” is not set. A column of “true” or “false” indicates that a determination value that is the determination result as to whether or not corresponding creation information satisfies the “condition of identification”, is used in identification of the program components. In the display 72, a column of creation information that satisfies the “condition of identification” is set to “true”, and a column of creation information that does not satisfy the “condition of identification” is set to “false”. In the case where the program components are identified in accordance with the identification pattern (1) illustrated in FIG. 5, regarding the “data type”, “comment”, and “affiliation”, the creation information itself registered in the program component table is used for identification of the program components. In addition, regarding the “data classification”, “update date and time”, and “creator”, the determination result as to whether or not the creation information registered in the program component table satisfies the corresponding “condition of identification”, is used for identification of the program components. Because the “data classification” of each of the program components No. 1 to No. 4 illustrated in FIG. 2 satisfies the “condition of identification”, the determination value of the “data classification” of each of No. 1 to No. 4 in the display 72 of FIG. 6 is “true”. In addition, because the “update date and time” of each of the program components No. 1 and No. 3 illustrated in FIG. 2 satisfies the “condition of identification”, the determination value of the “update date and time” of each of No. 1 and No. 3 in the display 72 of FIG. 6 is “true”. Because the “update date and time” of each of the program components No. 2 and No. 4 illustrated in FIG. 2 does not satisfy the “condition of identification”, the determination value of the “update date and time” of each of No. 2 and No. 4 in the display 72 of FIG. 6 is “false”. In addition, because the “creator” of each of the program components No. 1 and No. 3 illustrated in FIG. 2 does not satisfy the “condition of identification”, the determination value of the “creator” of each of No. 1 and No. 3 in the display 72 of FIG. 6 is “false”. Because the “creator” of each of the program components No. 2 and No. 4 illustrated in FIG. 2 satisfies the “condition of identification”, the determination value of the “creator” of each of No. 2 and No. 4 in the display 72 of FIG. 6 is “true”.

When the program components No. 1 and No. 2 of the program component table illustrated in FIG. 2 are compared with each other, the program components are different from each other in the data type, the determination value of the update date and time, the comment, and the determination value of the creator among the pieces of creation information to be used in identification of the program components. For that reason, the program components No. 1 and No. 2 are recognized as different program components. In addition, when the program components No. 1 and No. 3 are compared with each other, the program components are different from each other in the comment among the pieces of creation information to be used in identification of the program components. For that reason, the program components No. 1 and No. 3 are recognized as different program components. In addition, when the program components No. 1 and No. 4 are compared with each other, the program components are different from each other in the data type, the determination value of the update date and time, the comment, and the determination value of the creator among the pieces of creation information to be used in identification of the program components. For that reason, the program components No. 1 and No. 4 are recognized as different program components. In addition, when the program components No. 2 and No. 3 are compared with each other, the program components are different from each other in the data type, the determination value of the update date and time, the comment, and the determination value of the creator among the pieces of creation information to be used in identification of the program components. For that reason, the program components No. 2 and No. 3 are recognized as different program components. In addition, when the program components No. 2 and No. 4 are compared with each other, the program components coincide with each other in all the pieces of creation information to be used in identification of the program components, that is, the data type, the determination value of the data classification, the determination value of the update date and time, the comment, the determination value of the creator, and the affiliation. For that reason, the program components No. 2 and No. 4 are recognized as the same program components. In addition, when the program components No. 3 and No. 4 are compared with each other, the program components are different from each other in the data type, the determination value of the update date and time, the comment, and the determination value of the creator among the pieces of creation information to be used in identification of the program components. For that reason, the program components No. 3 and No. 4 are recognized as different program components.

Incidentally, by using the update date and time or the comment in identification of the program components, a frequency can be reduced of recognizing different program components to which the same names are given, as the same program components. By using both the update date and time and the comment, the frequency can be further reduced of recognizing different program components to which the same names are given, as the same program components.

Returning to explanation of FIG. 3, in step S14 described above, the identification pattern created in the past, that is, the identification pattern held by the program development support device 1, can be specified in addition to newly creating the identification pattern. In addition, in step S14 described above, the identification pattern specified from among the identification patterns created in the past is editable, that is, setting changes of the “presence or absence of identification” and the “condition of identification” illustrated in FIG. 5 and the like are possible.

The program development support device 1, when detecting operation indicating completion of specification work of the creation information to be used for identification of the program components, that is, completion operation of creating or editing work of the identification pattern (step S15), updates the identification pattern (step S16). That is, the creation information specifying unit 20, when accepting the completion operation of creating or editing work of the identification pattern from the user, stores the identification pattern in the storage unit 18 as described above.

The processing of steps S14 to S16 described above, that is, setting of the identification pattern may be executed in a case where predetermined operation is performed, instead of being executed every time creation or edition of one program component is completed. As the predetermined operation, a case is conceivable where operation for starting combining of the program components is performed, but operation other than this may be used as a trigger. In addition, the processing may be performed such that steps S14 to S16 are executed in a case where creation of the first program component is completed, and steps S14 to S16 are not executed at completion of creating the second and subsequent program components and at completion of editing the program component.

The user is allowed to specify the creation information to be used in identification of the program components by setting the identification pattern, whereby the following effects can be obtained. For example, in a case where different users agree in advance and create the same program components individually in different program development support devices 1, it becomes possible to deliberately duplicate the plural program components having the same contents created in the different program development support devices 1 by setting the identification patterns, and the program component can be made common. As described above, by using the identification pattern, both to treat program components having the same names as different program components and to treat the program components having the same names as the same program components are possible.

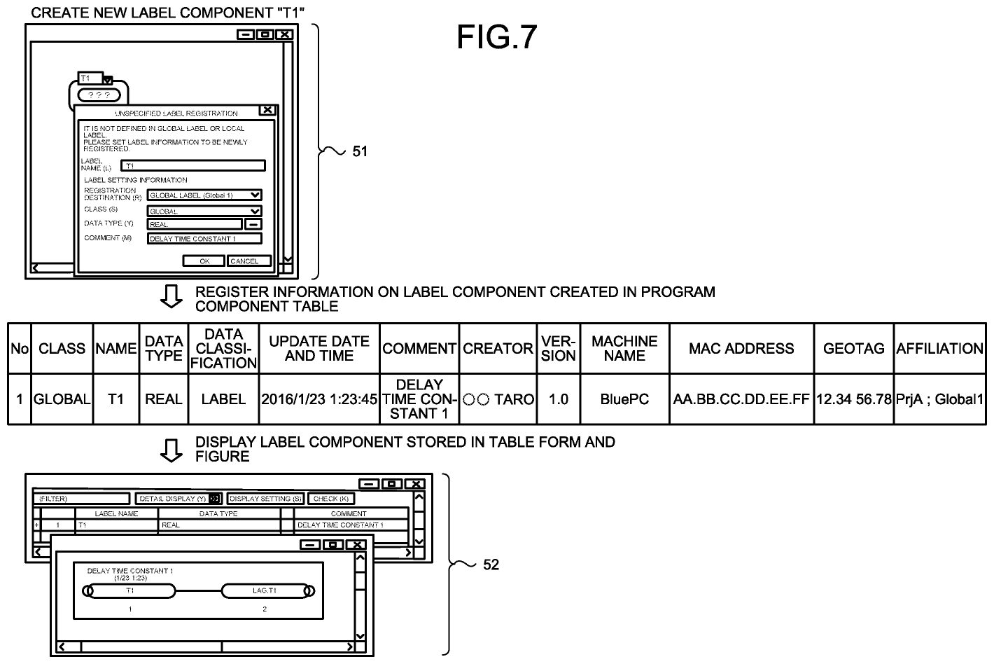

FIG. 7 is a diagram illustrating an operation example of the program development support device 1 according to the first embodiment, and illustrates an operation example corresponding to the flowchart illustrated in FIG. 3. The operation example illustrated in FIG. 7 is an operation example in a case where a label component having the name “T1” is created as a new program component. In addition, the operation example illustrated in FIG. 7 is an operation example in a case where information of the update date and time is specified as creation information to be used in identification of the program components.

In step S11, the program development support device 1 displays a screen 51 illustrated in FIG. 7 on the display unit 17, and accepts operation by the user, specifically, operation for creating the label component. When detecting completion of creating work of the label component, the program development support device 1 stores the label component created, and registers information of the label component created in the program component table. Thereafter, the program development support device 1 receives specification of the “update date and time” as the creation information to be used in identification of the program components, and then visualizes the program components based on the name and the update date and time, and displays on the display unit 17 a display screen 52 of the stored label component. The display screen 52 is an example in a case where the label component is displayed in a table form and a figure. As illustrated in the display screen 52, the program development support device 1 displays “T1” as the name of the label component, but does not display a name linking “T1” with the update date and time as the creation information. That is, the program development support device 1 identifies identity between the program components by using the “name” of the program component and the “update date and time” specified as the creation information to be used in identification of the program components, and manages the program components. On the other hand, when displaying the program component on the display unit 17, the program development support device 1 does not display the creation information to be used in identification of the program components, but displays the name of the program component, that is, the name given by the user to the program component.

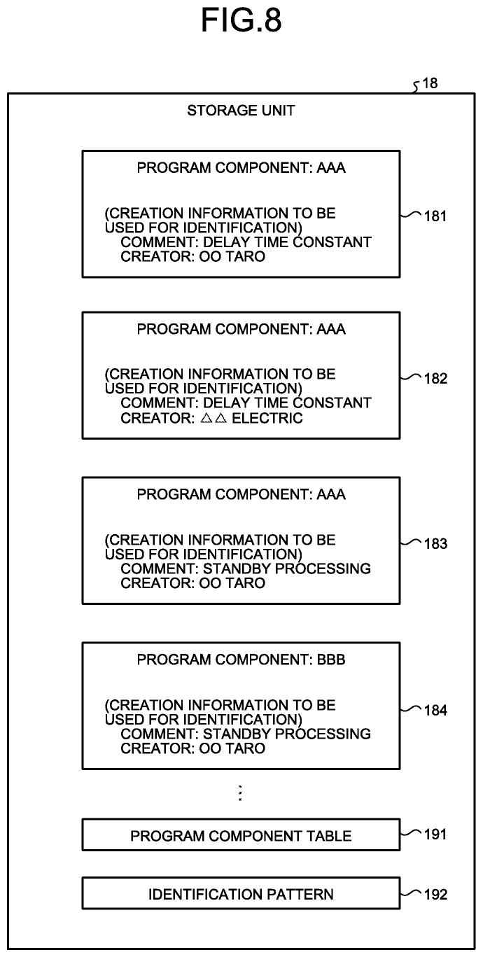

Next, a method will be described for identifying the program components by the program component managing unit 15 of the program development support device 1, with reference to the drawings. It is conceivable that the method for identifying the program components described here is used in a case where the program development support device 1 displays on the display unit 17 the program component stored in the storage unit 18, such as confirmation and edition of the program component already created. FIG. 8 is a diagram illustrating an example of data stored in the storage unit 18 of the program development support device 1. FIG. 8 illustrates an image of the data stored in the storage unit 18. As illustrated in FIG. 8, the storage unit 18 stores program components, a program component table, and an identification pattern. FIG. 8 illustrates an example in a case where program components 181 to 184 are included in the program components stored in the storage unit 18. In the example illustrated in FIG. 8, the names of the program components 181 to 183 are AAA, and the name of the program component 184 is BBB. In addition, among the pieces of creation information of each program component, the comment and the creator are specified by the user, as the specification information that is the creation information to be used for identification of the program components. Incidentally, the creation information to be used for identification of the program components is specified by an identification pattern 192. In addition, in FIG. 8, to make the explanation easier to understand, the creation information to be used for identification is described in each of rectangles indicating the program components 181 to 184, but each of the program components 181 to 184 does not include any creation information. All the pieces of creation information, that is, the pieces of creation information to be used for identification of the program components as the specification information and other pieces of creation information not corresponding to the specification information, are registered in a program component table 191.

In a case where the storage unit 18 stores the data of the contents illustrated in FIG. 8, with respect to the program components 181 to 183, the names coincide with each other, but the pieces of creation information to be used for identification of the program components are different from each other, so that the program component managing unit 15 determines that the program components 181 to 183 are different program components. Specifically, with respect to the program component 181 and the program component 182, the names and the comments each coincide with each other, but the creators are “OO Taro” and “ΔΔ Electric” and do not coincide with each other, so that the program component managing unit 15 determines that the program components 181 and 182 are different program components. In addition, with respect to the program component 181 and the program component 183, the names and the creators each coincide with each other, but the comments are the “delay time constant” and the “standby processing” and do not coincide with each other, so that the program component managing unit 15 determines that the program components 181 and 183 are different program components. Similarly, with respect to the program component 182 and the program component 183, the names coincide with each other, but the comments are the “delay time constant” and the “standby processing” that do not coincide with each other, and further, the creators are “OO Taro” and “ΔΔ Electric” that do not coincide with each other, so that the program component managing unit 15 determines that the program components 182 and 183 are different program components. Incidentally, with respect to the program component 183 and the program component 184, the pieces of creation information to be used for identification of the program components coincide with each other, but the names do not coincide with each other, so that the program component managing unit 15 determines that the program components 183 and 184 are different program components. Incidentally, if the comment of the program component 181 illustrated in FIG. 8 is the “standby processing”, the name, comment, and creator of the program component 181 coincide with the name, comment, and creator of the program component 183, so that the program component managing unit 15 determines that the program components 181 and 183 are the same program components. In addition, in a case where the pieces of creation information to be used for identification of the program components 181 to 184 are only comments, the name and comment of the program component 181 respectively coincides with the name and comment of the program component 182, so that the program component managing unit 15 determines that the program component 181 and the program component 182 are the same program components.

As described above, the program component managing unit 15 identifies the program components by using the name given to the program component, and the specification information that is the creation information specified by the user among various types of creation information of the program component. The creation information is information unique to the program component inevitably generated by creating or editing the program component. For that reason, even if the user of the program development support device 1, that is, a developer of the program gives the same names to different program components, the program development support device 1 can manage these program components as different program components, based on the creation information specified by the user among the pieces of creation information of the program component. As a result, even if different program components having the same names exist in the cases such as a case where the plural program components are displayed on the display unit 17, and a case where the names of the program components are listed and displayed on the display unit 17, the program component managing unit 15 identifies the program components, and for example, expresses the program components having the same names but each having different pieces of specification information in different colors, whereby the program development support device 1 can display on the display unit 17 the program components in a form visually recognizable by the user.

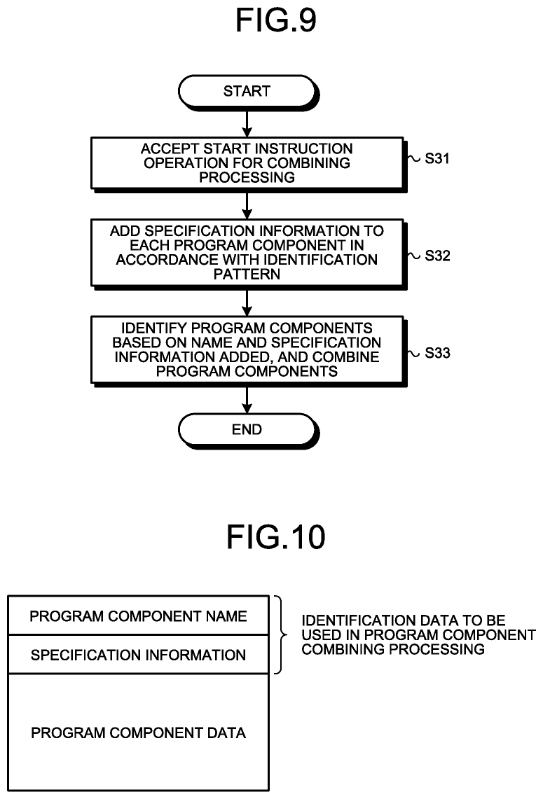

Next, operation will be described in which the program development support device 1 combines the program components. FIG. 9 is a flowchart illustrating an example of operation in which the program development support device 1 combines the program components to generate the executable file.

The program development support device 1, when accepting start instruction operation for program component combining processing from the user (step S31), starts the program component combining processing.

In the program component combining processing, the program development support device 1 first adds the specification information to each program component in accordance with the identification pattern stored in the storage unit 18 (step S32). Specifically, the program component managing unit 15 checks the identification pattern, and adds the creation information corresponding to the identification pattern to each program component, as the specification information. As a specific example, a case will be described where the program component table is the one illustrated in FIG. 2, and the identification pattern is the identification pattern (1) illustrated in FIG. 5. In this case, the program component managing unit 15 adds to the program component No. 1 the data type “REAL”, the determination value “true” of the data classification, the determination value “true” of the update date and time, the comment “delay time constant 1”, the determination value “false” of the creator, and the affiliation “PrjA; Global 1”. In addition, the program component managing unit 15 adds to the program component No. 2 the data type “TIMER”, the determination value “true” of the data classification, the determination value “false” of the update date and time, the comment “standby processing”, the determination value “true” of the creator, and the affiliation “PrjA; Global 1”. In addition, the program component managing unit 15 adds to the program component No. 3 the data type “REAL”, the determination value “true” of the data classification, the determination value “true” of the update date and time, the comment “measurement temperature 1”, the determination value “true” of the creator, and the affiliation “PrjA; Global 1”. In addition, the program component managing unit 15 adds to the program component No. 4 the data type “TIMER”, the determination value “true” of the data classification, the determination value “false” of the update date and time, the comment “standby processing”, the determination value “true” of the creator, and the affiliation “PrjA; Global 1”. Incidentally, for each determination value, it is conceivable to add ‘1’ if the determination value is “true”, and ‘0’ if the determination value is “false”; however, the value to be added is not limited to this.

Next, the program development support device 1 identifies the program components, based on the names of the program components and the pieces of specification information added, and creates the executable file, that is, combines the program components (step S33). In step S33, the program component managing unit 15 identifies the program components, and the program component combining unit 13 combines the program components, based on the identification result of the program components by the program component managing unit 15. In step S33, as illustrated in FIG. 10, the program component managing unit 15 combines the name of the program component and the specification information added, and treats them as identification data to be used in the program component combining processing, that is, identification data for identifying the identity between the program components when the program components are combined. FIG. 10 is a diagram illustrating a configuration example of the program component to which the specification information is added. The program component data are data such as the variable, the data type, the function, and the library that are program components. For example, in the case of the program component No. 1, the program component combining unit 13 combines the name “T1”, and the pieces of specification information added which include the data type “REAL”, the data classification “label”, the update date and time “2016/1/23 1:23:45”, the comment “delay time constant 1”, and the affiliation “PrjA; Global 1”, to make the identification data to be used in the program component combining processing.

As described above, the program development support device according to the first embodiment generates and holds the identification pattern that specifies at least one of the various types of creation information relating to creation of the program component, and identifies the program components by using the name of each program component and the specification information that is the creation information specified by the identification pattern among the pieces of creation information of each program component. In addition, when the program components are combined, the specification information that is the creation information specified by the identification pattern is added to the program component, and a combination of the name and the specification information is used as the identification data of the program component in the combining processing. As a result, the program development support device can identify program components even if the same names are given to the program components each having different pieces of creation information. In other words, the developer of the program can give the same names to the program components each having different pieces of creation information. In addition, the program development support device can prevent the identification data of the program component from being duplicated in the processing of combining the program components, so that work efficiency can be improved. That is, it becomes unnecessary for the user who is the developer of the program to perform work of giving different names in advance for each program component so as not to determine that the program components are duplicated in the combining processing, and work of eliminating duplication in a case where the names are duplicated. Incidentally, even in a case where the identification data is generated by combining the name and the specification information, there is a possibility that it is determined that the program components are duplicated in the combining processing. However, in this case, the user performs work of changing the identification pattern described with reference to FIG. 5, thereby it is possible to add or change the creation information to be used for generating the identification data and eliminate the duplication.

### Second Embodiment

In the first embodiment, the identification of the program components based on the name and the creation information has mainly been described; however, in a second embodiment, a display method of the program component will be described. A configuration of a program development support device according to the second embodiment is similar to that in the first embodiment. When displaying on the display unit 17 the program component stored, the program development support device according to the present embodiment is able to display a part or all of the corresponding name and creation information together.

Information to be displayed when the program development support device 1 displays the program component on the display unit 17 is information specified in advance by the user. Specification of the information to be displayed may be accepted by the creation information specifying unit 20 or accepted by another constituent element. In the second embodiment, an example will be described in which the creation information specifying unit 20 accepts the specification of the information to be displayed together with the program component.

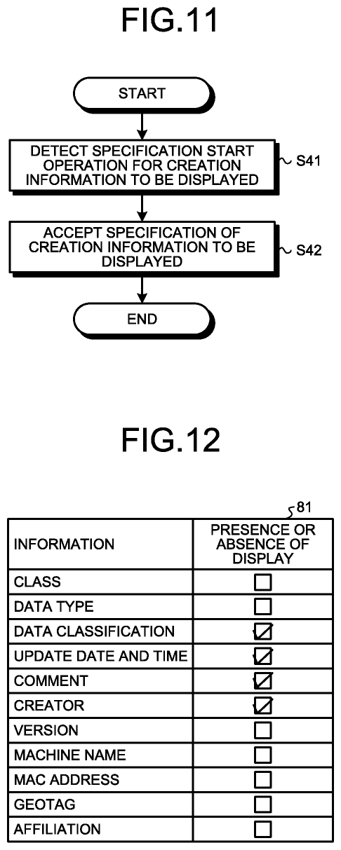

FIG. 11 is a flowchart illustrating an operation example of the creation information specifying unit 20, specifically, an operation example in a case where the specification of the information to be displayed together with the program component is accepted from the user.

The creation information specifying unit 20, when detecting that specification start operation for the creation information to be displayed together with the program component is performed by the user (step S41), displays a specification screen of the creation information to be displayed together with the program component on the display unit 17, and accepts the specification of the information by the user (step S42). When accepting the specification of the information by the user, the creation information specifying unit 20 generates information indicating contents accepted, that is, information indicating the creation information to be displayed together with the program component, and stores the information in the storage unit 18. In step S42, the creation information specifying unit 20 displays a display 81 illustrated in FIG. 12 on the display unit 17, and accepts the specification of the creation information to be displayed together with the program component. FIG. 12 is a diagram illustrating a display example of a menu screen that allows the user to specify the creation information to be displayed together with the program component.

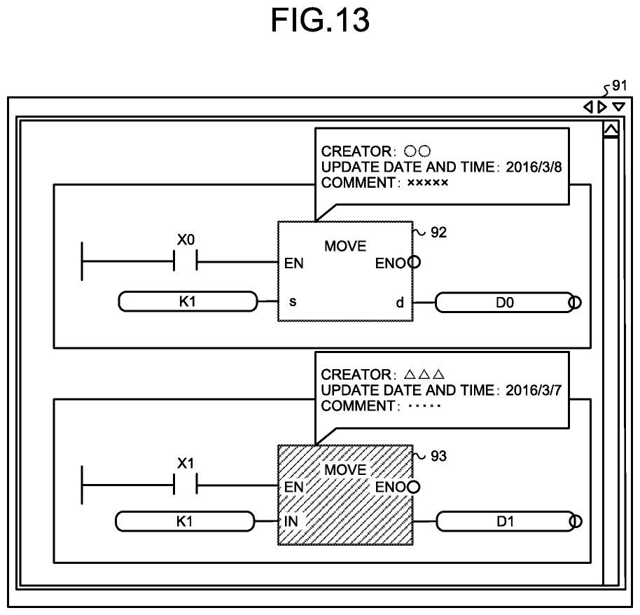

In a case where the program component is displayed on the display unit 17, the program component displaying unit 14 according to the second embodiment also displays the creation information specified by the user together. Incidentally, in a case where the user completes operation without checking the check boxes of “presence or absence of display” in the specification menu illustrated in FIG. 12, the program component displaying unit 14 does not display the creation information on the display unit 17. The display method for displaying the creation information is not limited; however, it is conceivable to adopt the display method illustrated in FIG. 13. FIG. 13 is a diagram illustrating a display example of the program components by the program development support device according to the second embodiment. As illustrated in FIG. 13, the program development support device 1 according to the second embodiment displays the creation information of the program component using characters in a pop-up form. By displaying the creation information together with the program component, it becomes possible for the user to identify whether the program components having the same names are truly the same as each other or different from each other. In the example illustrated in FIG. 13, when program components 92 and 93 to which the same names “MOVE” are given are displayed on a screen 91, the creation information, specifically, the creator, the update date, and the comment are displayed together. For that reason, the user can identify that the program component 92 and the program component 93 are different from each other.

Incidentally, the program development support device 1 may display the program components in different colors depending on individual values of the pieces of creation information so that the user can easily identify that the program component 92 and the program component 93 are different from each other. For example, in a case where the “creator” is specified as the creation information to be displayed together with the program component, and the program components having the same names but each having different creators are displayed, the program development support device 1 displays these program components in different colors. By changing the color to be displayed, it becomes possible for the user to intuitively identify whether or not the program components displayed are the same as each other, as compared with a case where only the creation information is displayed.

As described above, the program development support device according to the second embodiment displays the creation information together when displaying the program component, so that even when the plural program components having the same names exist, the user can identify whether or not the functions of the program components having the same names are the same as each other.

### Third Embodiment

When combining the program components, the program development support devices according to the first and second embodiments add, to the program component, the specification information that is the creation information specified from among the pieces of creation information which are relating to creation of the program component, and uses the combination of the name and the specification information, as the identification data in the combining processing. On the other hand, a program development support device according to a third embodiment generates, when combining the program components, a hash value based on information relating to the creation of the program component and adds the hash value to the program component. That is, in the third embodiment, a combination of the name and the hash value is used as the identification data in the combining processing. By adding the hash value to the program component, an increase can be suppressed in size of the information added to the program component. A configuration of the program development support device according to the third embodiment is similar to those in the first and second embodiments.

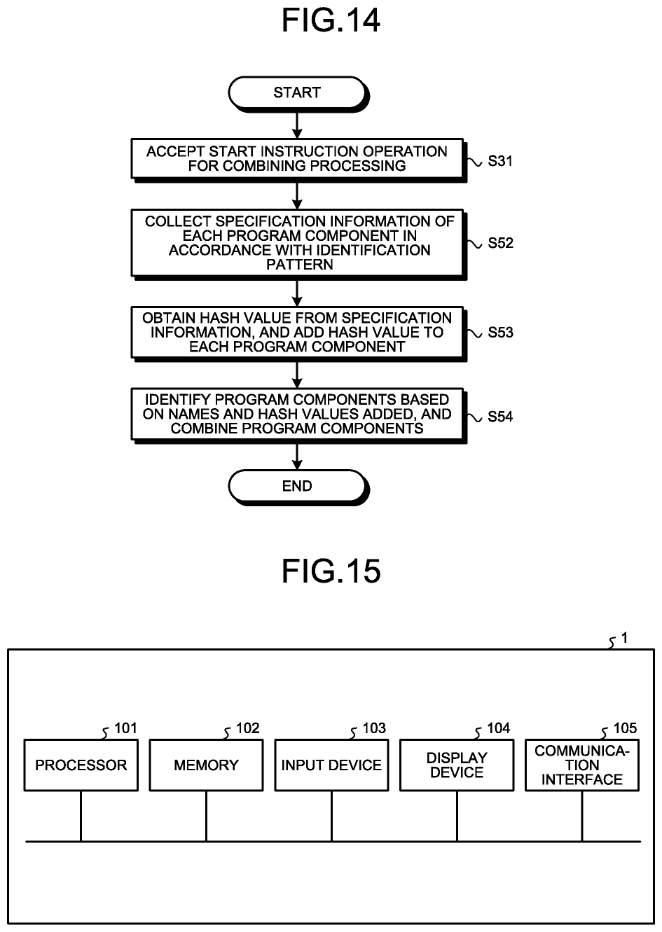

FIG. 14 is a flowchart illustrating an operation example of the program development support device according to the third embodiment, specifically, a flowchart of operation of combining the program components.

The program development support device 1 according to the third embodiment, when accepting start instruction operation for program component combining processing from the user (step S31), starts the program component combining processing. The processing of step S31 is the same as the processing of step S31 illustrated in

FIG. 9.

In the program component combining processing according to the third embodiment, the program development support device 1, in accordance with the identification pattern, first collects as the specification information the creation information specified by the identification pattern, among the pieces of creation information of each program component (step S52). The processing of step S52 is executed by the program component managing unit 15. Next, the program development support device 1 obtains a hash value by using the specification information collected in step S52, for each program component, and adds the hash value to each program component (step S53). The processing of step S53 is also executed by the program component managing unit 15. That is, the program component managing unit 15 calculates a hash value by using the creation information specified by the identification pattern for each program component, and adds the hash value calculated to the program component. As a specific example of steps S52 and S53, operation will be described in a case where the program component table is the one illustrated in FIG. 2, and the identification pattern is the identification pattern (1) illustrated in FIG. 5. In steps S52 and S53 for the program component No. 1, the program component managing unit 15 first collects the data type “REAL”, the determination value of the data classification, the determination value of the update date and time, the comment “delay time constant 1”, the determination value of the creator, and the affiliation “PrjA; Global 1” from among the pieces of creation information. Incidentally, the program component managing unit 15 obtains the determination value of the data classification, the determination value of the update date and time, and the determination value of the creator from the creation information read from the program component table. Specifically, the program component managing unit 15 obtains the determination value of the data classification from the data classification read from the program component table, obtains the determination value of the update date and time from the update date and time read from the program component table, and obtains the determination value of the creator from the creator read from the program component table. Next, the program component managing unit 15 calculates a hash value by using the pieces of creation information collected, and adds the hash value calculated to the program component No. 1. In addition, in steps S52 and S53 for the program component No. 2, the program component managing unit 15 first collects the data type “TIMER”, the determination value “true” of the data classification, the determination value “false” of the update date and time, the comment “standby processing”, the determination value “true” of the creator, and the affiliation “PrjA; Global 1” from among the pieces of creation information. Next, the program component managing unit 15 calculates a hash value by using the pieces of creation information collected, and adds the hash value calculated to the program component No. 2. The program component managing unit 15 also performs similar processing for the program component No. 3 and the program component No. 4.

Next, the program development support device 1 identifies the program components, based on the names of the program components and the hash values added, and creates an executable file, that is, combines the program components (step S54). In step S54, the program component managing unit 15 identifies the program components, and the program component combining unit 13 combines the program components, based on the identification result of the program components by the program component managing unit 15.

As described above, when combining the program components, the program development support device according to the third embodiment adds to the program component the hash value obtained based on the pieces of creation information relating to creation of the program component, and makes the combination of the name and the hash value as the identification data of the program component in the combining processing. As a result, an effect can be obtained similar to the effect in the first embodiment, and an increase can be suppressed in the data amount of the program components to be combined.

A configuration will be described of hardware that implements the program development support device 1 described in the first to third embodiments. The program development support device 1 can be implemented by a processor 101, a memory 102, an input device 103, a display device 104, and a communication interface 105 illustrated in FIG. 15. The processor 101 is a central processing unit (CPU) (also referred to as a central processing device, a processing device, an arithmetic device, a microprocessor, a microcomputer, a processor, or a DSP), a system large scale integration (LSI), or the like.

The memory 102 is a nonvolatile or volatile semiconductor memory such as a Random Access Memory (RAM), a Read Only Memory (ROM), a flash memory, an Erasable Programmable Read Only Memory (EPROM), or an Electrically Erasable Programmable Read Only Memory (EEPROM), a magnetic disk, a flexible disk, an optical disk, a compact disk, a mini disk, or a Digital Versatile Disc (DVD). The memory 102 holds a program for the processor 101 to operate as the program development support device 1. The memory 102 is also used as a work memory when the processor 101 executes various types of processing. In addition, the memory 102 constitutes the storage unit 18.

The input device 103 is a mouse, a keyboard, a touch panel, or the like, and constitutes the input unit 16 illustrated in FIG. 1. The display device 104 is a display or the like, and constitutes the display unit 17 illustrated in FIG. 1. The communication interface 105 is a network interface card or the like, and constitutes the communication unit 19 illustrated in FIG. 1.

In the case of implementing the management project changing unit 11, the program component creating unit 12, the program component combining unit 13, the program component displaying unit 14, the program component managing unit 15 and the creation information specifying unit 20 of the program development support device 1 by using the processor 101 and the memory 102 illustrated in FIG. 15, the memory 102 stores a program for implementing functions of these units, and the processor 101 reads and executes the program stored in the memory 102. That is, in the case of implementing the management project changing unit 11, the processor 101 reads a program from the memory 102 and executes the program for operating as the management project changing unit 11 enabled to execute processing of creating or changing a project and processing of transferring the program component between projects. In addition, in the case of implementing the program component creating unit 12, the processor 101 reads a program from the memory 102 and executes the program for operating as the program component creating unit that creates and edits the program component in accordance with operation performed by the user. In the case of implementing the program component combining unit 13, the processor 101 reads a program from the memory 102 and executes the program for operating as the program component combining unit 13 that combines the program components by using the name of the program component and the creation information specified by the user as the identification data of the program component. In the case of implementing the program component displaying unit 14, the processor 101 reads a program from the memory 102 and executes the program for operating as the program component displaying unit 14 that generates and displays various screen data for allowing the user to confirm the program components. In the case of implementing the program component managing unit 15, the processor 101 reads a program from the memory 102 and executes the program for operating as the program component managing unit 15 that identifies the program components by using the name of the program component and the creation information specified by the user. In the case of implementing the creation information specifying unit 20, the processor 101 reads a program from the memory 102 and executes the program for operating as the creation information specifying unit 20 that accepts from the user the specification of the creation information to be used in identification of the program components.

The configurations described in the above embodiments describe examples of contents of the present invention, and can be combined with other known techniques, and also a part of the configuration can be omitted or modified without departing from the gist of the present invention.

### REFERENCE SIGNS LIST

1 program development support device; 11 management project changing unit; 12 program component creating unit; 13 program component combining unit; 14 program component displaying unit; 15 program component managing unit; 16 input unit; 17 display unit; 18 storage unit; 19 communication unit; 20 creation information specifying unit.

1. A program development support device to manage program components on a project basis, the program development support device comprising:
a processor; and
a memory to store a program which, when executed by the processor, performs processes of:
adding a name to each of the program components; and
identifying identity between a plurality of the program components when the program components are combined, based on a program component name and specification information, the program component name being a name added by a user to corresponding one of the program components, the specification information being creation information specified by the user among a plurality of types of the creation information that is information relating to creation of the corresponding one program component.

2. The program development support device according to claim 1, wherein the processor further performs accepting specification of creation information to be used as the specification information in identification of the program components.

3. The program development support device according to claim 1, further comprising:
a display to display each of the program components together with the corresponding program component name.

4. The program development support device according to claim 3, wherein the display displays each of the program components together with the corresponding creation information.

5. The program development support device according to claim 4, wherein the display displays some of the program components each having different types of creation information in a form identifiable by the user when displaying the some of the program components to which an identical name is added.

6. The program development support device according to claim 1, wherein the specification information to be used in identification of the program components includes a creation date and time of each of the program components.

7. The program development support device according to claim 1, wherein the specification information to be used in identification of the program components includes a comment of each of the program components.

8. The program development support device according to claim 1, wherein
the processor further calculates a hash value based on the specification information, and identifies identity between the program components when the plurality of program components is combined, based on the program component name and the hash value.

9. The program development support device according to claim 1, wherein the processor further performs combining the plurality of program components, based on an identification result of the program components.

10. A computer implemented method for managing program components, comprising:
adding a name to each of the program components;
updating a program component table in which pieces of creation information is registered, each piece of the creation information being information relating to creation of corresponding one of the program components to which the name is added; and
identifying identity between a plurality of the program components when the program components are combined, based on each name and specification information, the specification information being creation information specified by a user among a plurality of types of the creation information that is information relating to creation of the corresponding one program component.
